(19) United States
(12) Patent Application Publication
(10) Pub. No.: US 2025/0354575 A1
(43) Pub. Date: Nov. 20, 2025

(54) Retention U-Nut

(71) Applicant: Illinois Tool Works Inc., Glenview, IL (US)

(72) Inventor: Kathryn G. Bailey, Farmington, MI (US)

(21) Appl. No.: 19/191,227

(22) Filed: Apr. 28, 2025

Related U.S. Application Data
(60) Provisional application No. 63/648,366, filed on May 16, 2024.

(51) Int. Cl. F16B 5/06; F16B 5/02

(52) U.S. Cl. CPC F16B 5/065; F16B 5/0258

(57) ABSTRACT

Described is a stamped-metal retainer clip for attaching a first component having a first opening relative to a second component having a second opening. The retainer clip includes a first planar portion, a second planar portion, a contact plate, and a fastener plate. The first planar portion and the second planar portion are resiliently connected via a first U-shaped bend. The contact plate is resiliently coupled with the second planar portion via a second U-shaped bend and includes a fastener opening to receive a fastener and a component-engagement feature to engage the first opening. The first planar portion and the second planar portion are spaced to define a channel configured to receive the first component. The fastener plate is resiliently coupled with the second planar portion via an angled bend and includes an internally-threaded collar to threadedly engage the fastener. Each of the contact plate and the fastener plate is positioned between the first planar portion and the second planar portion.

### RELATED APPLICATIONS

The present application claims priority to U.S. Provisional Patent Application No. 63/648,366, filed May 16, 2024, and entitled “Retention U-Nut,” which is hereby incorporated by reference in its entirety.

### BACKGROUND

Automotive components require fastening techniques that are simple to manufacture and assemble. Further, fastening techniques should above all be reliable and efficient.

Clips are widely used in various industries to secure, fasten, or retain components together. Traditional clip designs often rely on elastic deformation to generate a clamping force. However, excessive compression can lead to material fatigue, permanent deformation, or failure of either the clip or the components being secured. In sensitive applications—such as electronics, medical devices, or precision assemblies—there is a need to control the maximum compressive force applied to avoid damage.

Therefore, despite advancements to date, there is a need for a clip that provides reliable retention while incorporating features that limit the maximum compression force. Such a clip would enhance durability, protect delicate components, and ensure consistent performance over repeated use.

### SUMMARY

The present disclosure relates generally to a retention clip to form a connection between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an underside isometric assembled view of a fastening system with a retainer assembly having a retainer clip in accordance with an aspect of this disclosure.

FIG. 1b illustrates an isometric assembly view of the fastening system.

FIG. 1c illustrates a topside isometric assembled view of the fastening system.

FIGS. 1d and 1e illustrate cross-sectional isometric and side elevation views of the fastening system taken along cutline A-A (FIG. 1c).

FIG. 2a illustrates a topside isometric view of the retainer clip for FIGS. 1a through 1e.

FIG. 2b illustrates a cross-sectional view of the retainer clip taken along cutline B-B (FIG. 2d).

FIG. 2c illustrates a cross-sectional view of the retainer clip taken along cutline C-C (FIG. 2d).

FIG. 2d illustrates an elevation view of a first side the retainer clip.

FIG. 2e illustrates an elevation view of a second side the retainer clip.

FIG. 2f illustrates a cross-sectional view of the second side of the retainer clip taken along cutline D-D (FIG. 2a).

FIG. 3a illustrates a topside isometric view of a retainer clip in accordance with another aspect of this disclosure.

FIG. 3b illustrates an underside isometric view of the retainer clip of FIG. 3a.

FIGS. 3c and 3d illustrate, respectively, first and second side elevation views of the retainer clip of FIG. 3a.

FIGS. 3e and 3f illustrate, respectively, top and bottom plan views of the retainer clip of FIG. 3a.

FIGS. 3g and 3h illustrate, respectively, third and fourth side elevation views of the retainer clip of FIG. 3a.

FIG. 3i illustrates a cross-sectional view of the retainer clip taken along cutline E-E (FIG. 3h).

FIG. 3j illustrates a cross-sectional view of the retainer clip taken along cutline F-F (FIG. 3h).

FIG. 3k illustrates a cross-sectional view of the retainer clip taken along cutline G-G (FIG. 3e).

FIGS. 4a and 4b illustrate, respectively, underside isometric and side elevational views of a retainer clip having an internally-threaded collar of a first diameter (D1).

FIGS. 5a and 5b illustrate, respectively, underside isometric and side elevational views of a retainer clip having an internally-threaded collar of a second diameter (D2).

FIG. 6a illustrates a topside isometric view of a retainer clip in yet another example

FIG. 6b illustrates a cross-sectional view of the retainer clip taken along cutline H-H (FIG. 6d).

FIG. 6c illustrates a cross-sectional view of the retainer clip taken along cutline I-I (FIG. 6d).

FIG. 6d illustrates an elevation view of a first side the retainer clip.

FIG. 6e illustrates an elevation view of a second side the retainer clip.

FIG. 6f illustrates a cross-sectional view of the second side of the retainer clip taken along cutline J-J (FIG. 6a).

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a retention clip to form a connection between two components, such as vehicular components.

In one example, a stamped-metal retainer clip for attaching a first component having a first opening relative to a second component having a second opening comprises: a first planar portion and a second planar portion that are resiliently connected via a first U-shaped bend; a contact plate resiliently coupled with the second planar portion via a second U-shaped bend and comprising a fastener opening configured to receive a fastener and a component-engagement feature configured to engage the first opening, wherein the first planar portion and the second planar portion are spaced to define a channel configured to receive the first component; and a fastener plate resiliently coupled with the second planar portion via an angled bend and comprising an internally-threaded collar configured to threadedly engage the fastener, wherein each of the contact plate and the fastener plate is positioned between the first planar portion and the second planar portion.

In another example, a retainer clip for attaching a first component having a first opening relative to a second component having a second opening comprises: a first planar portion and a second planar portion that are resiliently connected to one another; a contact plate resiliently coupled with the second planar portion and comprising a fastener opening configured to receive a fastener; and a fastener plate resiliently coupled with the second planar portion and comprising an internally-threaded collar configured to threadedly engage the fastener, wherein each of the contact plate and the fastener plate is positioned between the first planar portion and the second planar portion.

In yet another example, a retainer assembly for attaching a first component having a first opening relative to a second component having a second opening comprises: a fastener having a head and a shank; and a stamped-metal retainer clip comprising: a first planar portion and a second planar portion that are resiliently connected to one another; a contact plate resiliently coupled with the second planar portion and comprising a fastener opening configured to receive the shank; and a fastener plate resiliently coupled with the second planar portion and comprising an internally-threaded collar configured to threadedly engage the shank, wherein each of the contact plate and the fastener plate is positioned between the first planar portion and the second planar portion.

In some examples, the first planar portion, the second planar portion, the fastener plate, and the contact plate are parallel to one another.

In some examples, the contact plate comprises a component-engagement feature configured to engage the first opening.

In some examples, the first planar portion and the second planar portion are spaced to define a channel configured to receive the first component.

In some examples, the fastener plate is coupled with the second planar portion via an angled bend such that the fastener plate is offset relative to the second planar portion.

In some examples, the component-engagement feature is an annular ridge.

In some examples, the component-engagement feature is a generally U-shaped body.

In some examples, the component-engagement feature comprises a pair of wings.

In some examples, the pair of wings protrude toward the first planar portion.

In some examples, the pair of wings are positioned on opposed sides of the fastener opening.

In some examples, the retainer clip further comprises a guide lip positioned adjacent an opening to the channel and configured to guide the first component into the channel.

In some examples, the guide lip is coupled to the contact plate.

In some examples, the retainer clip is a stamped-metal component.

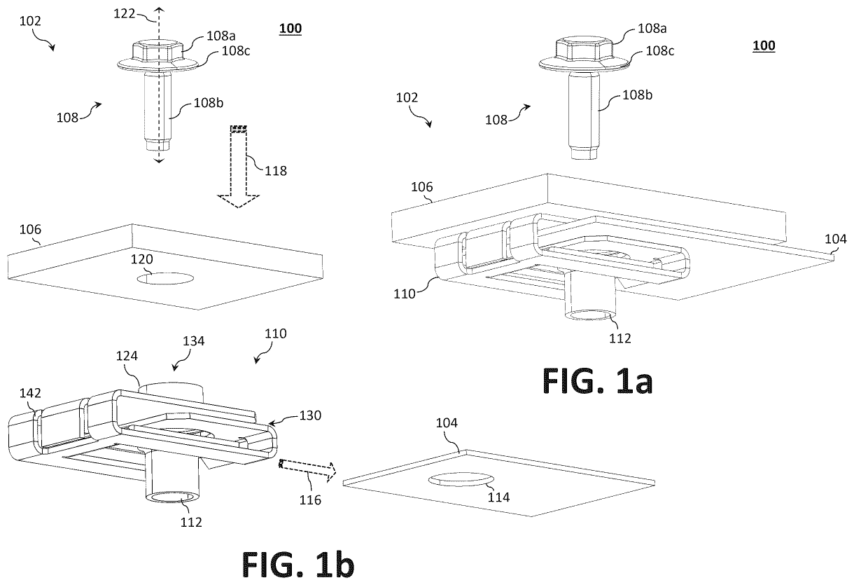

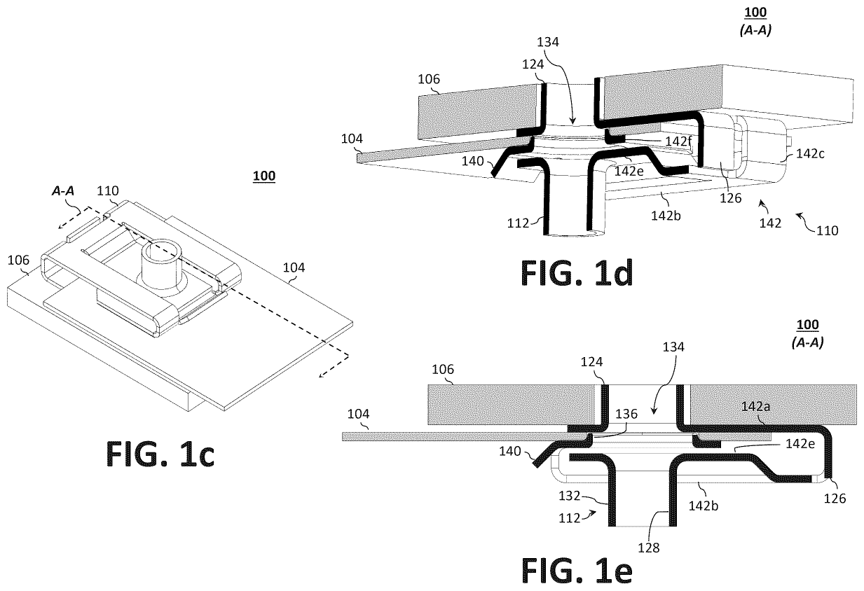

FIG. 1a illustrates an underside isometric assembled view of a fastening system 100 including a retainer assembly 102 having a retainer clip 110, in accordance with an aspect of this disclosure. FIGS. 1b and 1c illustrate, respectively, isometric assembly and topside isometric assembled views of the fastening system 100. FIGS. 1d and 1e illustrate, respectively, cross-sectional isometric and side elevation views of the fastening system 100 taken along cutline A-A of FIG. 1c. The illustrated fastening system 100 includes the first component 104, the second component 106, and a retainer assembly 102. The retainer assembly 102 is configured to join the first component 104 and the second component 106, while providing, inter alia, compression limiting and retention features.

To facilitate attachment via the retainer assembly 102, each of the first component 104 and the second component 106 includes one or more engagement features. For example, the first component 104 is illustrated as having a first opening 114 formed therein and the second component 106 is illustrated as having a second opening 120 formed therein. In the illustrated example, the first opening 114 is circular and configured to receive and engage the retainer clip 110, while the second opening 120 is circular and sized and shaped to receive a portion of the fastener 108.

The first opening 114 and the second opening 120 can be formed in the respective first component 104 or second component 106 during manufacturing thereof or added post-manufacture through a mechanical process (e.g., drilling, cutting, carving, etc.). After the first component 104 and the second component 106 are assembled, as best illustrated in FIG. 1a, the second component 106 covers the first component 104 at least partially.

The retainer assembly 102 is illustrated as a multi-component retainer assembly 102 having a fastener 108 (e.g., an externally-threaded shaft, such as a bolt) and a retainer clip 110 (e.g., a metal retainer clip) that comprises a body portion 142 with, inter alia, a compression limiter 124 and an internally-threaded collar 112. As will be described in connection with other examples, the compression limiter 124 and the internally-threaded collar 112 can be integrated with the retainer clip 110. The retainer clip 110 serves to mechanically engage and couple with the first component 104 via the first opening 114, while the fastener 108 and the internally-threaded collar 112 serve to couple the first component (via the retainer clip 110) to the second component 106 (via its second opening 120). The internally-threaded collar 112 can comprise a cylinder body 132 that defines an internally-threaded bore 128 configured to threadedly engage the shank 108b.

It is contemplated that certain components of the multi-component retainer assembly 102 may be fabricated as a stamped-metal component using a metal-stamping technique. For example, the retainer clip 110 can be fabricated from a single sheet of metal and stamped/bent using a metal-stamping technique, while the fastener 108 can be fabricated from metal via one or more metal-shaping techniques, such as cold forging. In another example, the retainer clip 110 can be fabricated as a stamped-metal component, whereas the fastener 108 can be fabricated from a plastic material using a plastic injection technique, additive manufacturing, or otherwise. In some examples, one or more components of the retainer assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first component 104 and second component 106 include, without limitation, door trim panels, moldings, trim pieces, and other substrates (whether used as interior or exterior surfaces), automotive panels, structural components of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

As illustrated, the fastener 108 comprises a head 108a, a shank 108b, and a flange 108c. In this example, the fastener 108 includes a head 108a that is hex-shaped to facilitate tool engagement, such as with a socket, screwdriver, or wrench, and a shank 108b that is externally threaded to engage with an internal thread. The flange 108c serves to increase the contact surface area between the head 108a and the second component 106, distributing the clamping load and minimizing localized stress concentrations. While the fastener 108 is illustrated as a threaded bolt having a hexagonal head 108a, other types of fasteners, including square-headed fasteners, are contemplated for use depending on the application requirements.

During installation, as best illustrated in FIGS. 1a and 1b, the retainer clip 110 is slipped onto an edge of the first component 104 as indicated by arrow 116 such that the compression limiter 124 and the internally-threaded collar 112 are generally aligned with the first opening 114 formed in the first component 104. As will be described, the retainer clip 110 can be configured to engage the first component 104 with a snap-fit or interference fit to retain itself prior to final assembly. Once the retainer clip 110 is installed, the second component 106 is positioned over the retainer clip 110 and lowered, as indicated by arrow 118, such that the compression limiter 124 is inserted into the second opening 120. With reference to FIG. 1a, the shank 108b of the fastener 108 can then be inserted through the compression limiter 124, the first component 104, the second component 106, and the retainer clip 110 to threadedly engage the internally-threaded collar 112, thus forming a connection.

The fastener 108 can be rotated relative to the internally-threaded collar 112 about its axis of rotation 122 to join and compress the first component 104 and second component 106 relative to one another. In this example, the internally-threaded collar 112 is rotationally fixed relative to the retainer clip 110 and the first and second components 104, 106 to prevent spinout during installation. As will be described in greater detail, the compression limiter 124 serves to limit axial displacement and excessive compression loads on the second component 106, thereby protecting material integrity. Additional features of the retainer clip 110 provide alignment, positional stability, and tactile feedback during the assembly process.

Accordingly, the first opening 114 is sized and shaped to receive and retain the retainer clip 110 and to allow passage of the fastener shank 108b. In the illustrated example, the first opening 114 is generally circular but may optionally include chamfers, fillets, or other features to facilitate centering and insertion. A portion of the first component 104 is clamped or sandwiched between opposing portions of the retainer clip 110 such that a fastener opening 134 formed in the retainer clip 110 is coaxially aligned with the first opening 114 and, ultimately, with the second opening 120 formed in the second component 106.

In some examples, the retainer assembly 102 comprises a seal disposed to mitigate dust, dirt, water, or other environmental contaminants from passing through the first opening 114 and/or the second opening 120. The seal may be embodied as a ring (e.g., an annulus) formed from compressible or resilient materials such as closed-cell foam, thermoplastic elastomer (TPE), rubber, or silicone. In one example, the seal is positioned radially about the fastener shank 108b and axially between the second component 106 and the underside of the head 108a to form a fluid-tight or particulate-resistant barrier.

The illustrated retainer clip 110 comprises a body portion 142 that defines a channel 130 (e.g., a generally U-shaped channel) dimensioned to receive and retain a portion of the first component 104. The illustrated body portion 142 is formed as a pair of opposing first and second planar portions 142a, 142b, which are resiliently connected by an integral spring bend 142c (e.g., a U-bend). The planar portions 142a, 142b exert a clamping force on the first component 104 upon insertion into the channel 130, providing mechanical retention. The planar portions are configured to default to a predetermined, unstressed shape.

The illustrated second planar portion 142b is stamped and bent to form a fastener plate 142e and a contact plate 142f, each of which extends from the second planar portion 142b and is resiliently connected thereto. The fastener plate 142e is resiliently coupled at an end adjacent the bend 142c and is offset via an angled bend 142g to facilitate alignment during fastener engagement. The contact plate 142f is resiliently coupled near a guide lip 140 at the entrance to the channel 130 via bends 142d (illustrated as a pair of spaced-apart U-shaped bends). The fastener plate 142e comprises or defines the internally-threaded collar 112, which may be formed by extrusion, punching, or thread-forming operations. The guide lip 140 can be inclined relative to the longitudinal axis of the clip to deflect and guide the first component 104 into the channel 130 during installation, reducing the potential for misalignment or jamming.

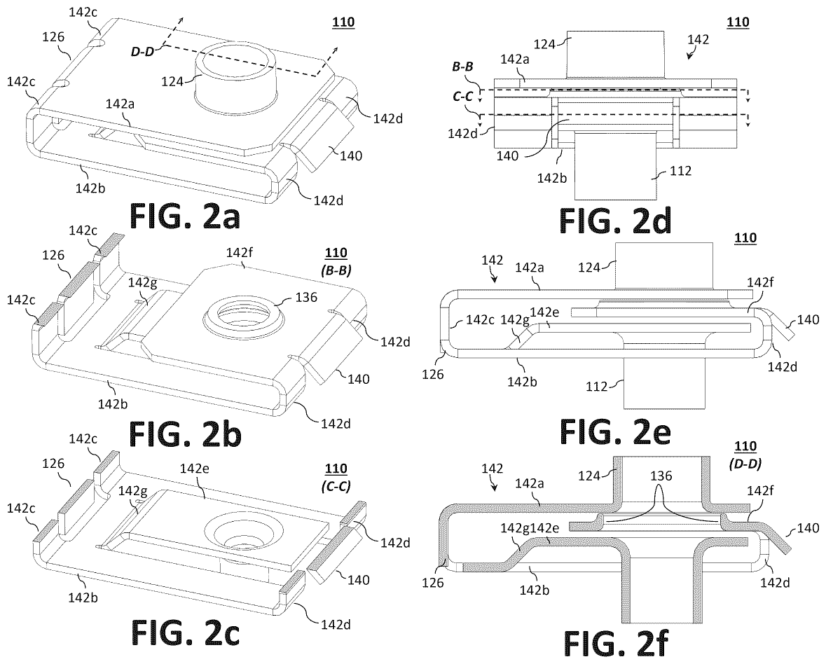

With reference to FIGS. 2e and 2f, the first planar portion 142a, second planar portion 142b, fastener plate 142e, and contact plate 142f are arranged substantially parallel to one another. In this example, the fastener plate 142e and contact plate 142f are punched from and/or integrally formed from the first planar portion 142a and bent such that they are parallel to one another and positioned between the first planar portion 142a and second planar portion 142b. The first planar portion 142a and the contact plate 142f are spaced apart by a distance from one another to define the channel 130, which is dimensioned to accommodate a thickness of the first component 104 while maintaining a sufficient clamping force.

The first planar portion 142a integrally includes the compression limiter 124. The compression limiter 124 is, in the illustrated example, a hollow cylindrical body (e.g., an unthreaded extruded cylindrical wall) sized to slidingly receive the 108b of the fastener 108 and to insert into the second opening 120. The compression limiter 124 operates to transfer compressive loads directly between the first component 104 and the second component 106, minimizing material creep or crushing. The compression limiter 124 and the internally-threaded collar 112 are generally concentric and oriented in opposed directions, wherein the compression limiter 124 extends upwardly and the internally-threaded collar 112 extends downwardly relative to the first planar portion 142a.

The contact plate 142f defines a fastener opening 134 and, in addition, a component-engagement feature 136. The component-engagement feature 136 is formed in or on the contact plate 142f of the retainer clip 110 and is configured to mechanically engage corresponding features of the first component 104, producing audible and tactile feedback during installation. In this example, with reference to FIG. 2b, the component-engagement feature 136 is an annular ridge shaped to snap into the first opening 114 of the first component 104. The component-engagement feature 136 provides axial retention of the retainer clip 110 onto the first component 104 via an interference fit and prevents undesired dislodgment prior to fastener installation. As illustrated in FIGS. 1d and 1e, the component-engagement feature 136 projects into the first opening 114 to maintain positioning. For example, the component-engagement feature 136 enables the retainer clip 110 to be preinstalled on the first component 104 as a part-in-assembly (PIA), thereby reducing assembly time, ensuring positional accuracy, and streamlining manufacturing operations.

The retainer clip 110 further comprises a sidewall 126, positioned between the bends 142c, configured to serve as a manipulation point during handling and assembly. The sidewall 126 may be engaged manually or with an insertion tool to facilitate axial displacement of the clip 110 onto the first component 104 during installation.

The various features of the retainer clip 110 (e.g., compression limiter 124, internally-threaded collar 112, component-engagement feature 136, sidewall 126) can be stamped, punched, coined, and/or extruded from the material of the body portion 142. The features are subsequently bent into final shape through forming operations to produce a structurally integral and dimensionally stable retainer clip 110 optimized for high-volume manufacturing.

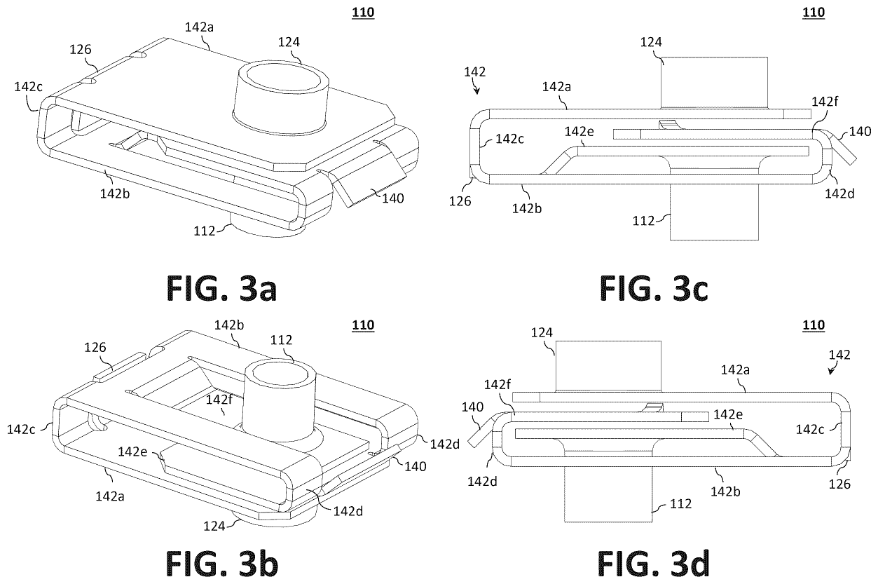

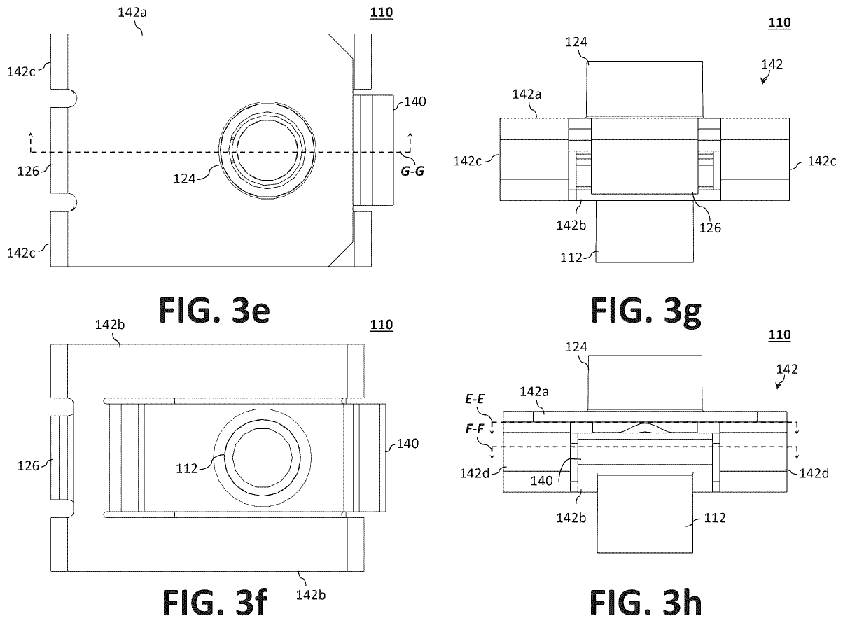

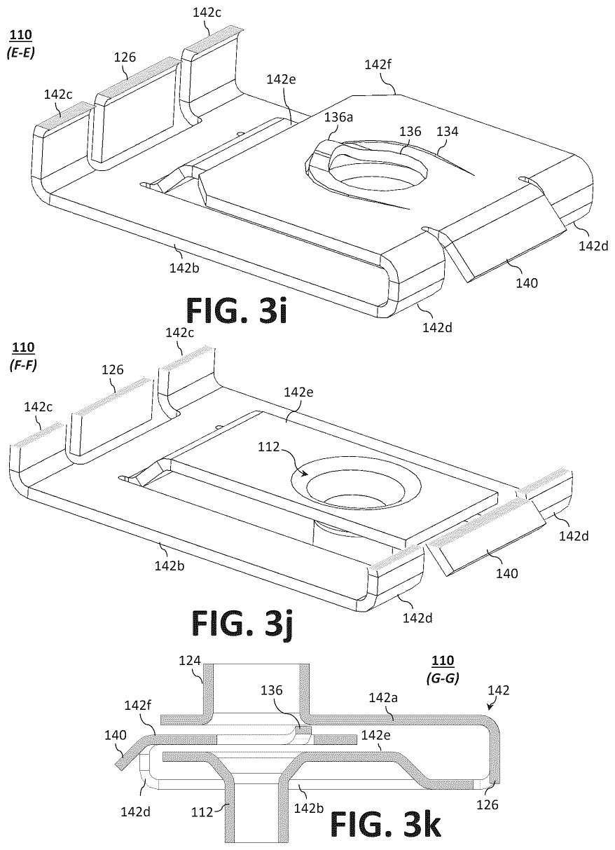

FIGS. 3a through 3h illustrate various views of a retainer clip 110 in accordance with another aspect of this disclosure. The retainer clip 110 of FIGS. 3a through 3k is substantially similar to that of FIGS. 2a through 2d, except for the configuration of the component-engagement feature 136.

FIGS. 3a and 3b illustrate, respectively, topside and underside isometric views of the retainer clip 110. FIGS. 3c and 3d illustrate, respectively, first and second side elevation views. FIGS. 3e and 3f illustrate, respectively, top and bottom plan views, and FIGS. 3g and 3h illustrate third and fourth side elevation views of the retainer clip 110. FIGS. 3i through 3k illustrate cross-sectional views of the retainer clip 110 shown in FIGS. 3a through 3h. FIG. 3i illustrates a cross-section taken along cutline E-E of FIG. 3h; FIG. 3j illustrates a cross-section taken along cutline F-F of FIG. 3h; and FIG. 3k illustrates a cross-section taken along cutline G-G of FIG. 3e.

While the component-engagement feature 136 of the prior examples is illustrated as an annular ridge, other shapes are contemplated. In this example, with reference to FIG. 3i, the component-engagement feature 136 positioned on the contact plate 142f of the retainer clip 110 is generally U-shaped (e.g., a horseshoe or Omega ((2) shape) and configured to protrude upward via a protrusion 136a formed at its apex to snap into a first opening 114 on the first component 104, thus providing audible and tactile feedback during installation onto the first component 104. In the illustrated example, the component-engagement feature 136 is positioned within the fastener opening 134 (e.g., formed along the inner perimeter of the fastener opening 134) and is generally U-shaped to at least partially encircle or surround the shank 108b when assembled.

The size of the compression limiter 124 and the internally-threaded collar 112 can be adjusted to accommodate fasteners 108 of various sizes and second components 106 of various sizes. For example, the diameter can be dictated by the size of the fastener 108, which can be a metric size (e.g., M2, M2.5, M3, M3.5, M4, M4.2, M4.8, M5, M5.5, M6, M6.3, M8, M10, M12, M16, M20, etc.) or an imperial (inch-based) size (e.g., #2, #4, #6, #8, #10, #12, ¼″, 5/16″, ⅜″, ½″, etc.). Similarly, the height (H) of the compression limiter 124 can be dictated by the thickness of the second component 106.

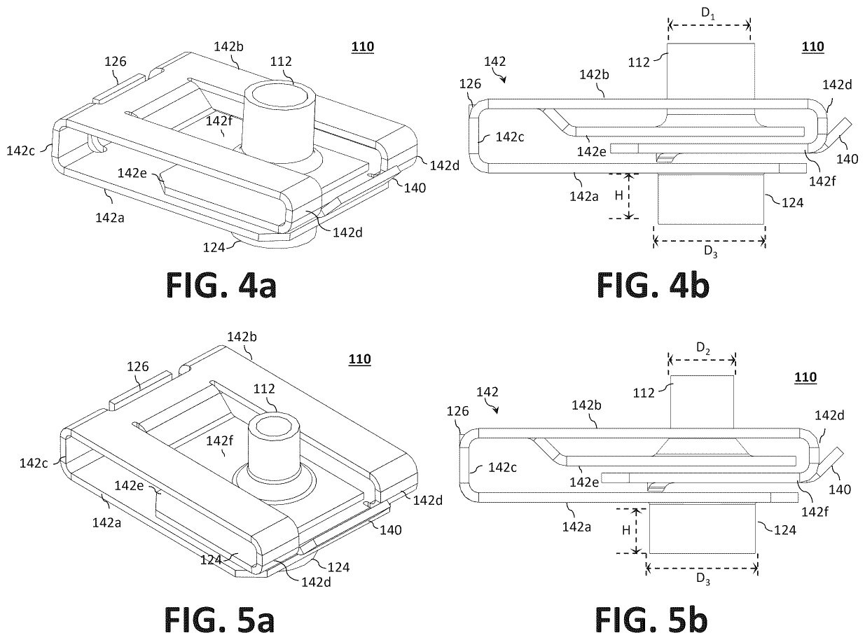

FIGS. 4a and 4b illustrate, respectively, underside isometric and side elevation views of a retainer clip 110 having an internally-threaded collar 112 of a first diameter (D1), while FIGS. 5a and 5b illustrate, respectively, underside isometric and side elevation views of a retainer clip 110 having an internally-threaded collar 112 of a second diameter (D2). In this example, the first diameter (D1) is larger than the second diameter (D2). The first diameter (D1) can be, for example, configured for use with an M6 fastener, while the second diameter (D2) can be configured for use with an M4.2 fastener. In these examples, the third diameter (D3) of the compression limiter 124 is the same but could similarly be adjusted based on the size of the fastener 108. The height (H) of the compression limiter 124 can be dictated by the thickness of the second component 106; however, the same height (H) is illustrated in each of FIGS. 4b and 5b.

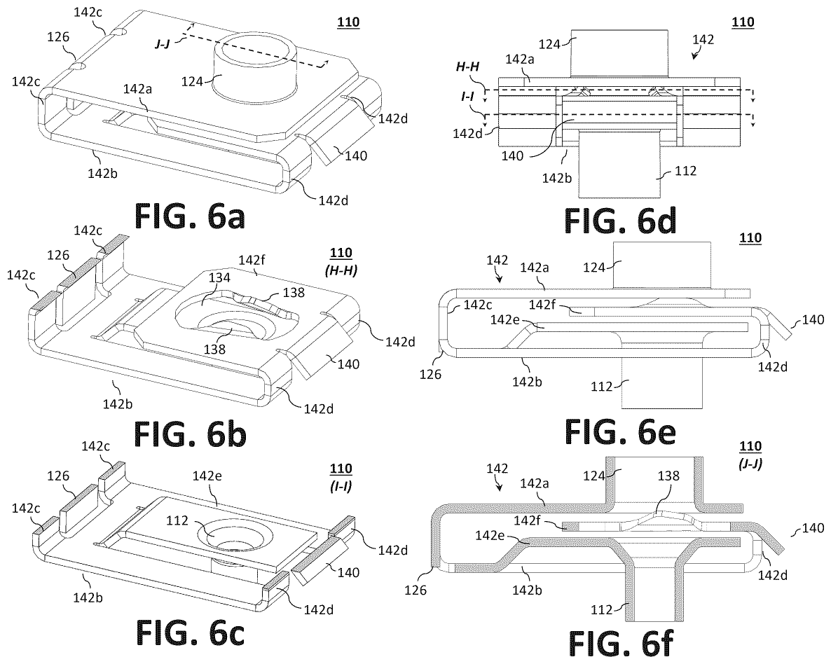

FIGS. 6a through 6f illustrate various views of a retainer clip 110 in accordance with another aspect of this disclosure. FIG. 6a illustrates a topside isometric view. FIGS. 6b and 6c illustrate, respectively, cross-sectional views taken along cutlines H-H and I-I of FIG. 6d. FIGS. 6d and 6e illustrate, respectively, elevation views of first and second sides of the retainer clip 110. FIG. 6f illustrates a cross-sectional view of the second side taken along cutline J-J of FIG. 6a. The retainer clip 110 of FIGS. 6a through 6f is substantially similar to that of FIGS. 2a through 2d, except for the configuration of the component-engagement feature 136.

While the component-engagement feature 136 of the prior examples is illustrated as an annular ridge or generally U-shaped, other shapes are contemplated. In this example, with reference to FIG. 6b, the component-engagement feature 136 positioned on the contact plate 142f of the retainer clip 110 comprises a pair of wings 138 configured to protrude upward on two opposed sides to snap into a first opening 114 on the first component 104, thus providing audible and tactile feedback during installation onto the first component 104. In this example, the fastener opening 134 is non-circular. In the illustrated example, the component-engagement feature 136 is positioned on two sides of the fastener opening 134.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A stamped-metal retainer clip for attaching a first component having a first opening relative to a second component having a second opening, the stamped-metal retainer clip comprising:
a first planar portion and a second planar portion that are resiliently connected via a first U-shaped bend;
a contact plate resiliently coupled with the second planar portion via a second U-shaped bend and comprising a fastener opening configured to receive a fastener and a component-engagement feature configured to engage the first opening,
wherein the first planar portion and the second planar portion are spaced to define a channel configured to receive the first component; and
a fastener plate resiliently coupled with the second planar portion via an angled bend and comprising an internally-threaded collar configured to threadedly engage the fastener,
wherein each of the contact plate and the fastener plate is positioned between the first planar portion and the second planar portion.

2. The stamped-metal retainer clip of claim 1, wherein the first planar portion, the second planar portion, the fastener plate, and the contact plate are parallel to one another.

3. A retainer clip for attaching a first component having a first opening relative to a second component having a second opening, the retainer clip comprising:
a first planar portion and a second planar portion that are resiliently connected to one another;
a contact plate resiliently coupled with the second planar portion and comprising a fastener opening configured to receive a fastener; and
a fastener plate resiliently coupled with the second planar portion and comprising an internally-threaded collar configured to threadedly engage the fastener,
wherein each of the contact plate and the fastener plate is positioned between the first planar portion and the second planar portion.

4. The retainer clip of claim 3, wherein the first planar portion, the second planar portion, the fastener plate, and the contact plate are parallel to one another.

5. The retainer clip of claim 3, wherein the contact plate comprises a component-engagement feature configured to engage the first opening.

6. The retainer clip of claim 3, wherein the first planar portion and the second planar portion are spaced to define a channel configured to receive the first component.

7. The retainer clip of claim 3, wherein the fastener plate is coupled with the second planar portion via an angled bend such that the fastener plate is offset relative to the second planar portion.

8. The retainer clip of claim 5, wherein the component-engagement feature is an annular ridge.

9. The retainer clip of claim 5, wherein the component-engagement feature is a generally U-shaped body.

10. The retainer clip of claim 5, wherein the component-engagement feature comprises a pair of wings.

11. The retainer clip of claim 10, wherein the pair of wings protrude toward the first planar portion.

12. The retainer clip of claim 10, wherein the pair of wings are positioned on opposed sides of the fastener opening.

13. The retainer clip of claim 3, further comprising a guide lip positioned adjacent an opening to the channel and configured to guide the first component into the channel.

14. The retainer clip of claim 13, wherein the guide lip is coupled to the contact plate.

15. The retainer clip of claim 3, wherein the retainer clip is a stamped-metal component.

16. A retainer assembly for attaching a first component having a first opening relative to a second component having a second opening, the retainer assembly comprising:
a fastener having a head and a shank; and
a stamped-metal retainer clip comprising:
a first planar portion and a second planar portion that are resiliently connected to one another;
a contact plate resiliently coupled with the second planar portion and comprising a fastener opening configured to receive the shank; and
a fastener plate resiliently coupled with the second planar portion and comprising an internally-threaded collar configured to threadedly engage the shank,
wherein each of the contact plate and the fastener plate is positioned between the first planar portion and the second planar portion.

17. The retainer assembly of claim 16, wherein the first planar portion, the second planar portion, the fastener plate, and the contact plate are parallel to one another.

18. The retainer assembly of claim 16, wherein the contact plate comprises a component-engagement feature configured to engage the first opening.

19. The retainer assembly of claim 16, wherein the fastener plate is coupled with the second planar portion via an angled bend such that the fastener plate is offset relative to the second planar portion.

20. The retainer assembly of claim 16, wherein the retainer clip is a stamped-metal component.
